(19) United States
(12) Patent Application Publication
(10) Pub. No.: US 2008/0288221 A1
(43) Pub. Date: Nov. 20, 2008

(54) METHOD AND APPARATUS FOR GENERATING ANALYSIS MESH

(75) Inventor: Teruhiko Tomohiro, Nara (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 12/119,978

(22) Filed: May 13, 2008

(30) Foreign Application Priority Data
May 18, 2007 (JP) 2007-132516

(51) Int. Cl. G06F 17/50

(52) U.S. Cl. 703/1

(57) ABSTRACT

Even in the case where there is an analysis mesh but no source 3D-CAD model remains, the present invention can easily modify a shape and efficiently create an analysis mesh. The present invention divides the analysis mesh into closed areas in a division step and stores the closed areas combined with attribute information on physical properties and meshes as a partial area in a partial area registration step, defines a total area in a total area registration step, changes the shape of a partial area desired to be changed in a partial area changing step, changes an arrangement in a partial area moving step, then constructs an analysis model by combining the partial areas and the total area in an area merging step and finally performs mesh division in a mesh division step.

### FIELD OF THE INVENTION

The present invention relates to a CAE (computer aided engineering) analysis method using a computer and an apparatus, and more particularly, to a method and an apparatus for, when performing a thermal liquid analysis, modifying an analysis mesh and simply creating a partially different analysis mesh.

### BACKGROUND OF THE INVENTION

When using a CAR analysis in design, research and development of a product, design drawings and CAD data cannot be directly analyzed and it is necessary to create analysis meshes obtained by dividing an analysis target into small areas. This is because the CAE analysis uses a technique of expressing dynamic phenomena and complicated physical phenomena of a fluid using differential equations and calculating discretized algebraic equations using a computer.

The analysis mesh is obtained by dividing an area to be analyzed into small portions and often uses a 3D-CAD model of the analysis target as source shape data. When an analysis is made, objects of completely different shapes are rarely analyzed and compared, whereas objects of the same basic shape and partially different shapes are often compared and the quality thereof is compared and examined. The number of analysis targets to be compared and examined can be two or three, or several tens of types may also be examined. In such a case, it is often impossible to change the shape of the analysis mesh itself using commercially available analysis tools, and therefore a procedure for modifying the shape of a source 3D-CAD model using some methods and then creating analysis mesh again is followed. When it is known beforehand that a plurality of types of configuration will be examined, it is possible to efficiently create analysis meshes by creating a plurality of types of 3D-CAD model in consideration of the shape to be examined. However, it is actually often the case that new shapes are improved and created while proceeding with examinations, and therefore new shapes are created by modifying the source 3D-CAD model.

However, partially modifying the shape of the 3D-CAD model and modifying combinations with other parts without inconsistencies constitute work that requires more time and effort as the shape becomes more complicated. In the case of a 3D-CAD model in a fluid analysis in particular, both a solid part and a fluid part need to be created and modification of the shape is more complicated.

Therefore, a method of easily creating a 3D-CAD model whose partial shape is changed is designed. For example, there is a method whereby a 3D-CAD model and a wire frame model which is the source of the solid shape are associated with each other and stored and a new 3D-CAD model is constructed by modifying the wire frame model. This is constructed of functional blocks as shown in FIG. 12. In FIG. 12, in order to modify each of a plurality of types of solid model, the shape data of a shape data file in a shape data file storage unit 31 is sequentially changed by a changing unit 32. A definition data updating unit 33 updates a cross-sectional shape and attribute defined to generate a solid model for each component based on the shape data in the changed shape data file according to the correspondence between a preset wire frame model and the solid model. A solid model modification unit 34 then sequentially generates a plurality of types of modified solid models by operating a solid modeler 35 based on the cross-sectional shape updated by the definition data updating unit 33 and the attribute thereof. The shape data stored by the shape data file storage unit 31 is two-dimensional graphics represented by a wire frame whose shape data is made up of lines in the space. The changing unit 32 causes a common image output apparatus to display the wire frame model on a screen so as to make it possible to compare correlations between their respective components and changes the cross-sectional shapes of the respective components displayed on the screen according to a predetermined change input operation.

According to this method, in a defined data updating step based on the shape data in the shape data file sequentially changed in the changing step, at least one of the cross-sectional shape and attribute defined to generate the solid model for each component according to the preset correspondence is updated. Furthermore, in a solid model modification step, the solid modeler 35 is operated based on the cross-sectional shape and attribute, at least one of which is updated, and thereby a plurality of types of modified solid models are sequentially generated. Therefore, after collectively changing cross-sectional shapes of the respective components, solid models of a plurality of components are automatically sequentially generated without requiring manpower. Therefore, hours during which the designer is bound to the terminal of the machine are drastically reduced, for example, to less than half and high design efficiency is obtained. JP3059867B (see line 11 on the left column on page 6 to line 43 on the right column on page 7, FIGS. 2 to 4)

However, this technique is based on the premise that the solid model and the wire frame model associated with each other beforehand are defined in a database or requires that each model be created and the correspondence thereof be defined. That is, when change locations to be examined from now on and a change pattern are determined, such a method can be used to proceed with the work efficiently. However, even when an analysis is made and the shape is changed based on the result, it is difficult to define the general correspondence beforehand.

Furthermore, in an actual development operation, modifying and examining the shape analyzed in the past often turn out to be more efficient. In such a case, it is often the case that there is an analysis mesh but the 3D-CAD model forming the basis thereof does not remain and modifying the shape requires a 3D-CAD model be newly created, which unfortunately cannot be said to be efficient.

### DISCLOSURE OF THE INVENTION

The present invention is intended to solve the aforementioned problems and it is an object of the present invention to provide a method and apparatus for creating an analysis mesh capable of modifying the analysis mesh and easily creating a partially different analysis mesh.

In order to attain the aforementioned object, the analysis mesh creation method according to the present invention includes a division step of dividing an analysis mesh into a plurality of closed areas having information on a shape and position, a partial area registration step of storing the closed areas combined with attribute information on physical properties and meshes as a partial area, a total area registration step of storing a total area which is an area combining all the partial areas and having attribute information on the specific partial area, a partial area changing step of changing the partial area desired to be changed, a partial area moving step of optionally changing a position of the partial area, an area merging step of constructing a new analysis model by combining the total area and the at least one partial area using the position information, and mesh division step of performing mesh division on the constructed analysis model and thereby creating a new analysis mesh.

Using the procedure according to this configuration, an analysis mesh is divided into a plurality of closed areas having information on the shape and position in the division step first, the closed area together with attribute information on physical properties and meshes is stored as the partial area in the partial area registration step and at the same time the total area combining all the partial areas and having a physical property value of the specific partial area is stored in the total area registration step.

Next, the partial area desired to be changed is optionally changed in the shape changing step, the position of the partial area is further optionally changed in the partial area moving step and then a new analysis model is constructed by combining the total area and the at least one partial area using the position information in the area merging step.

Finally, a new analysis mesh is created by carrying out the mesh division step of dividing the mesh of the analysis model constructed in the mesh division step.

Furthermore, the analysis mesh creation apparatus of the present invention includes an input apparatus, a calculation apparatus, a storage apparatus and a display apparatus, wherein the calculation apparatus includes division unit that divides an analysis mesh into a plurality of closed areas, a partial area registration unit that stores the closed areas combined with attribute information on physical properties and meshes as partial areas, a total area registration unit that stores a total area having attribute information of the specific partial area, a partial area changing unit that changes the partial area desired to be changed, a partial area moving unit that optionally changes a position of the partial area, an area merging unit that constructs a new analysis model by combining the total area and the at least one partial area using the position information and mesh division unit that performs mesh division on the constructed analysis model.

As described above, according to the analysis mesh creation method of the present invention, it an analysis mesh remains, it is possible to change the shape without any source 3D-CAD model and create a new analysis mesh and there is no necessity for time and effort to newly create a 3D-CAD model and thereby produce the effect of efficiently examining the shape through a CAE analysis.

Furthermore, by dividing an area into the total area and partial area, modifying the shape of a partial area desired to be changed and then merging both areas, it is possible to obtain the effect of reducing time and effort required for modification compared to a case where the entire area is handled as partial areas.

Furthermore, since the analysis mesh creation apparatus of the present invention is provided with a unit capable of changing the shape without any source 3D-CAD model and creating a new analysis mesh as long as the analysis mesh remains, there is no need for time and effort to newly create a 3D-CAD model and it is possible to provide an apparatus capable of efficiently examining the shape through a CAE analysis.

### BRIEF DESCRIPTION OF THE DRAWINGS

FIG. 1 is a block diagram of an analysis mesh creation apparatus according to an embodiment of the present invention;

FIG. 2 is a flowchart of an analysis mesh creation method according to the embodiment of the present invention;

FIG. 3 illustrates a relationship between a total area and partial areas;

FIG. 4 is a table diagram showing a closed area and attribute information of a partial area;

FIG. 5 is a plan view showing an air channel;

FIG. 6 is a plan view showing a situation in which the partial area is divided;

FIG. 7 is a plan view showing a situation in which the partial area is modified to a different partial area;

FIG. 8 is a plan view showing a partial area moving step;

FIG. 9 illustrates a situation of an analysis mesh of the air channel;

FIG. 10 illustrates a situation of an analysis mesh in the partial area moving step;

FIG. 11 illustrates a situation of an analysis mesh in the mesh division step; and

FIG. 12 is a functional block diagram illustrating main parts of a conventional analysis model creation apparatus.

### DESCRIPTION OF THE EMBODIMENTS

Hereinafter, an embodiment of the present invention will be explained with reference to the attached drawings.

### Embodiment 1

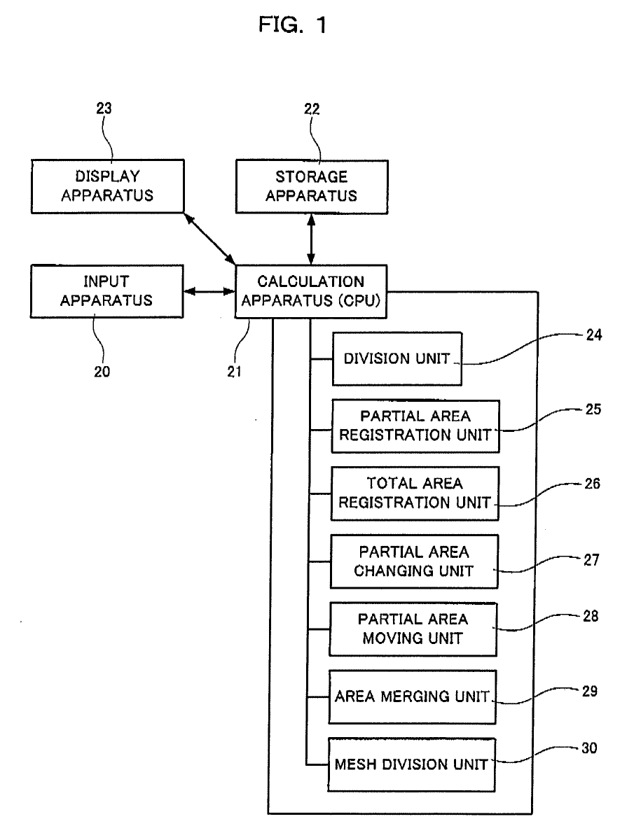

FIG. 1 is a functional block diagram of an analysis mesh creation apparatus according to Embodiment 1 of the present invention. An input apparatus 20 represents a keyboard or mouse, a calculation apparatus 21 represents a CPU or MPU, a storage apparatus 22 represents an HDD or flash memory or the like, a display apparatus 23 represents a display such as a liquid crystal or CRT. The input apparatus 20, storage apparatus 22 and display apparatus 23 are individually connected to the calculation apparatus 21.

The calculation apparatus 21 is provided with a division unit 24 that divides an analysis mesh into a plurality of closed areas having information on a shape and position, a partial area registration unit 25 that stores the closed areas combined with attribute information on physical properties and meshes as partial areas, a total area registration unit 26 that stores a total area which is an area combining all the partial areas and having specific attribute information on the partial area, a partial area changing unit 27 that changes the partial area desired to be changed, a partial area moving unit 28 that optionally changes a position of the partial area, an area merging unit 29 that constructs a new analysis model by combining the total area with the at least one partial area using the position information, and mesh division unit 30 that creates a new analysis mesh by carrying out mesh division step of performing mesh division on the constructed analysis model. These processing units may take any one of a mode in which the processing units are stored in a manner not detachable from an HDD or memory apparatus in the calculation apparatus 21 and a mode in which the processing units are stored in an external HDD or memory apparatus as a program, made separable or movable and temporarily stored in the storage apparatus 22 and controlled by the calculation apparatus 21.

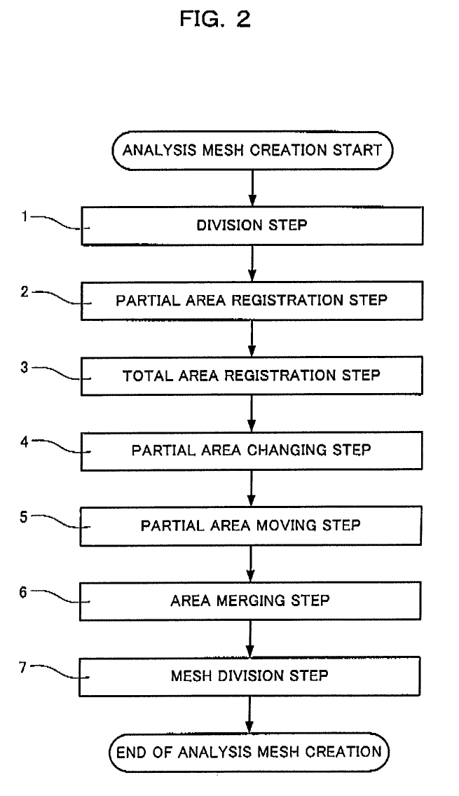

FIG. 2 is a flowchart showing a procedure of an analysis mesh creation method for the analysis mesh creation apparatus of the present invention. Since this flowchart and the respective units of the calculation apparatus 21 associated with each other, explanations hereafter will be focused on the flowchart in connection with the calculation apparatus 21.

In FIG. 2, reference numeral 1 denotes a division step of dividing an analysis mesh into a plurality of closed areas having information on the shape and position.

Reference numeral 2 denotes a partial area registration step of storing the closed areas combined with attribute information on physical properties and meshes as partial areas.

Reference numeral 3 denotes a total area registration step of storing a total area which is an area combining all the partial areas and having attribute information of the specific partial area.

Reference numeral 4 denotes a partial area changing step of changing the partial area desired to be changed.

Reference numeral 5 denotes a partial area moving step of optionally changing the position of the partial area.

Reference numeral 6 denotes an area merging step of constructing a new analysis model by combining the total area and the at least one partial area using the position information.

Reference numeral 7 denotes mesh division step of creating a new analysis mesh by carrying out mesh division step of performing mesh division on the constructed analysis model.

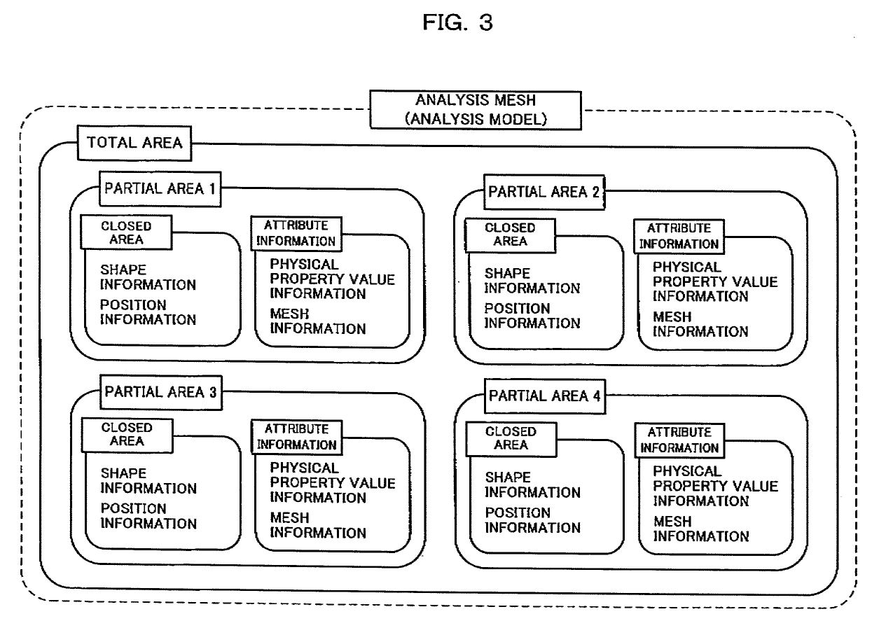

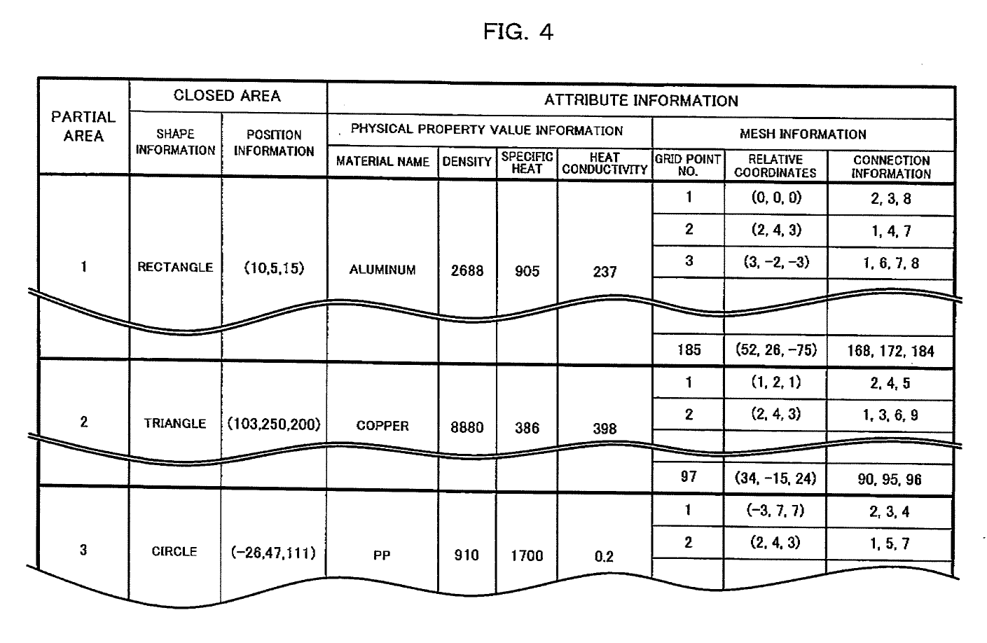

FIG. 3 illustrates a relationship between the closed area, attribute information, partial area and total area in the aforementioned flowchart and FIG. 4 illustrates a table diagram showing the closed area and contents of the attribute information. As shown in FIG. 3, the partial area is made up of a closed area and attribute information, and a set of the partial areas constitutes the total area. The closed area is made up of shape information and position information and the attribute information is made up of physical property value information and mesh information. The shape information of the closed area shows the shapes of closed areas, for example, obstacles 13 to 16, walls 11 and 12, which will be described later, such as rectangle and triangle as shown in FIG. 4. The position information indicates the position of the total area in which the closed area (partial area) exists as coordinates. The physical property value information of the attribute information is information indicating the name of material such as aluminum and copper, density, specific heat, heat conductivity or the like. The mesh information indicates relative coordinates of a mesh and connection information which will be described later.

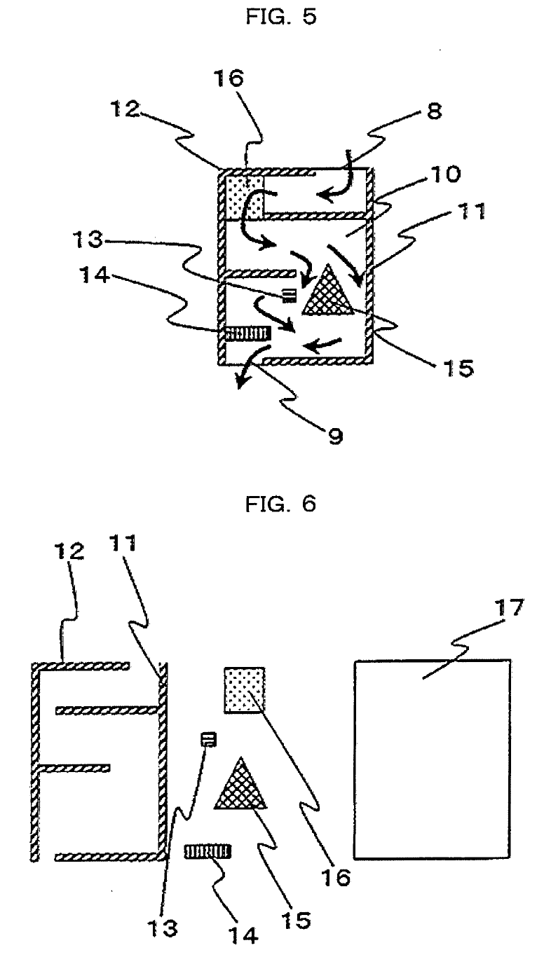

A specific work procedure for creating an analysis mesh will be explained according to the flowchart in FIG. 2 using examples in FIGS. 5 to 8. FIG. 5 is a plan view to illustrate the channel in an easily comprehensible way. This channel is made up of obstacles 13, 14, 15 and 16 arranged in a space partitioned by F-shaped walls 11 and 12 facing each other in mutually opposite directions and provided with an inlet 8 at the top and an outlet 9 at the bottom. A fluid (air) is indicated by arrows and the obstacles 13 to 15 are made of a substance that air cannot pass through, while the obstacle 16 is assumed to be made of a substance that air can pass through. Reducing pressure loss in the channel in which the obstacles 13 to 16 exist and making the velocity distribution in the channel uniform are items to be examined that frequently appear in the development of an apparatus.

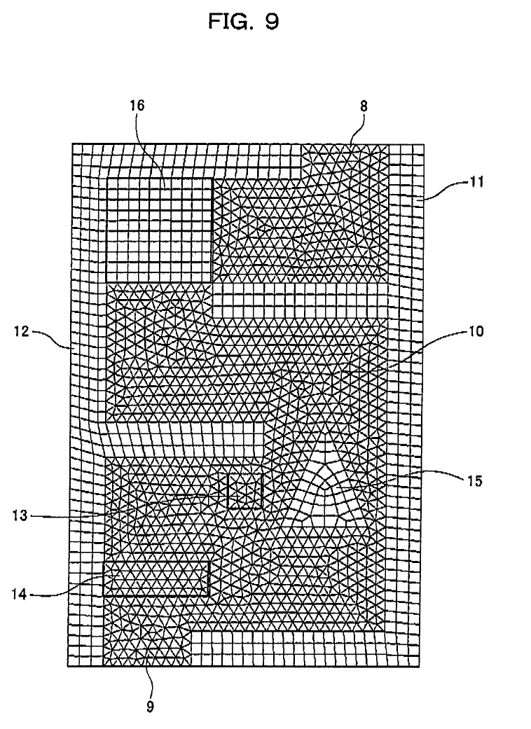

FIG. 5 omits a mesh, but the mesh is actually represented by a divided mesh as shown in FIG. 9. That is, FIG. 9 shows an appearance of an analysis mesh of the air channel, which is an analysis mesh for a CAE analysis provided with mesh-divided information for an analysis of the entire channel. Reference numerals in FIG. 9 are the same reference numerals used for the members in FIG. 5, and therefore explanations thereof will be omitted. As for the correspondence between FIG. 3 and FIG. 5, the respective closed areas correspond to the obstacles 13 to 16 and the walls 11 and 12 and the partial areas include the physical property value information and mesh information of the obstacles 13 to 16 and walls 11 and 12.

In the division step 1 of the flowchart, the analysis mesh 10 in FIG. 9 is divided into a plurality of closed areas (partial areas). Unlike CAD data, the analysis mesh generally has no such concepts as surface or volume, but has grid point No. of the divided mesh, relative coordinates of sides and connection information. Furthermore, the analysis mesh also has physical property value information necessary for an analysis, that is, information on what element is made of what material. For example, as FIG. 4 describes that the partial area 1 is made of aluminum and the partial area 2 is made of copper, the individual analysis meshes have physical property value information of what material the individual areas are made. The closed area (partial area) can be divided by categorizing mesh elements of the same material under one group according to this physical property value information. That is, since all analysis targets normally have any one physical property value, it is possible to divide the area according to the physical property value information and divide the analysis mesh 10 into a plurality of partial areas without dropouts or overlaps. This division step 1 is performed by the division unit 24 in FIG. 1 in the analysis mesh creation apparatus.

FIG. 6 shows a situation in which a division is made as closed areas (partial areas) and a division is made with the walls 11, 12, obstacles 13, 14, 15 and 16 as the respective partial areas. Though not shown here, the air area, that is, the area obtained by removing the walls and obstacles 11 to 16 from the analysis mesh 10 is also categorized as one partial area.

Next, in the partial area registration step 2, physical property value information and mesh information are added to the respective closed areas divided in the preceding division step as attribute information and registered. The mesh information refers to relative coordinates and connection information of mesh of the source analysis mesh 10. The relative coordinate information may be absolute coordinates relative to the source analysis mesh 10 but may also be position information whereby relative positions of the respective closed areas (partial areas) can be at least defined in the total area. This partial area registration step 2 is performed by the partial area registration unit 25 in the analysis mesh creation apparatus and the closed areas and attribute information are stored in the storage apparatus 22.

The total area registration step 3 is a step of registering the entire area to be analyzed including all the closed areas divided in the partial area registration step 2 as one area.

More specifically, in addition to the walls 11, 12 and obstacles 13 to 16, the aforementioned area in which the air flows is included and registered as a total area 17.

In this total area 17, specific physical property value information on the air or the like and mesh information are also added as the attribute information. This total area registration step 3 is performed by the total area registration unit 26 in the analysis mesh creation apparatus.

The work of modification of analysis mesh starts from here. Partial area changing step 4 is a step of changing the shape of the partial area registered in partial area registration step 2 and allows any type of change from a partial change of the shape of a closed area (partial area) to an entire change. When the shape of the closed area (partial area) is changed, the shape information or mesh information of the closed area is changed, and therefore part or the whole of the mesh information may be lost, but the physical property value information is maintained. This partial area changing step 4 is performed by the partial area changing unit 27 in the analysis mesh creation apparatus.

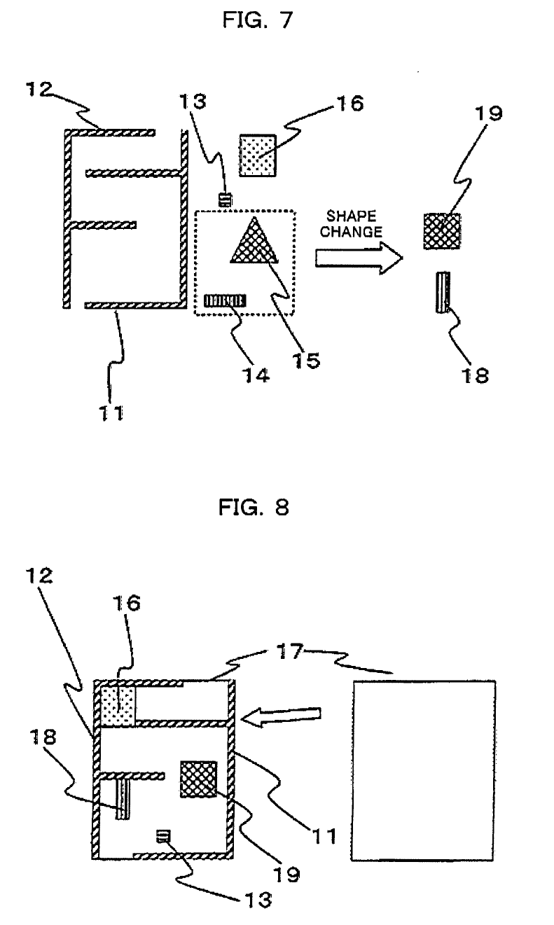

FIG. 7 shows a situation in which the closed areas (partial areas) 14 and 15 are modified to different closed areas (partial areas) 18 and 19 to which the areas are desired to be changed. In the figure, the triangular closed area (partial area) 15 is modified to a square closed area 19 and the horizontal rectangular closed area (partial area) 14 is modified to a longitudinal closed area (partial area) 18.

Though not shown in FIG. 7, a guite new partial area may also be added as special processing of partial area changing step 4 here. Only the physical property value information is given as the attribute information in this case and no information on grid points is provided.

Partial area moving step 5 is a step of arranging the respective closed areas (partial areas) at any positions of the total area 17. Since the respective partial areas have mesh information as the attribute information, that is, relative coordinates of mesh and connection information, even when relative coordinates of mesh at any one point in the partial area are specified and the closed area is moved to a certain point in the total area 17, it is possible to move the position of the closed area (partial area) while maintaining the shape information of the closed area and the mesh information of the attribute information. This partial area moving step 5 is performed by the partial area moving unit 28 in the analysis mesh creation apparatus.

FIG. 8 shows a situation of partial area moving step 5 in which a plurality of closed areas (partial areas) are placed overlapped on the total area 17. While the locations of the partial areas 11, 12 and 16 are the same as those of the source analysis mesh 10, the shapes of the partial areas 14 and 15 are modified into the partial areas 18 and 19 as described above and the locations thereof are also changed. The shape of the partial area 13 is not changed but the position is changed.

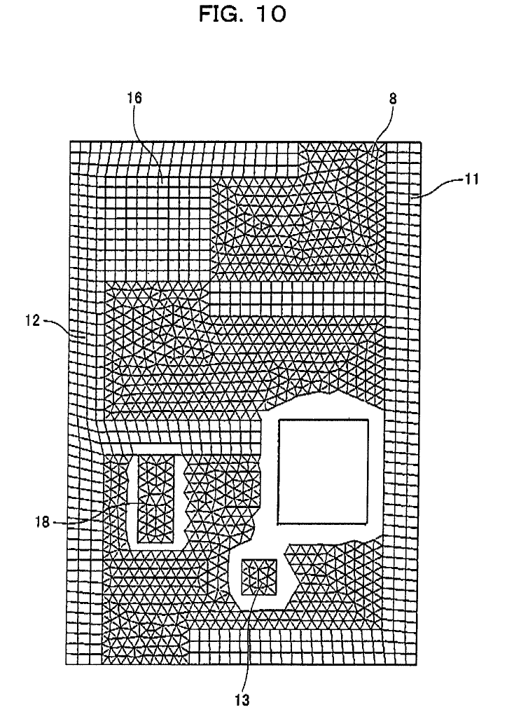

FIG. 10 shows a situation of partial area moving step 5 using divided meshes. Mesh information on lost mesh contacts is created through mesh-division again in mesh division step 7 which will be described later, and as a condition for mesh division thereof, it is also possible to add the division size and number on the boundary edges of the part whose shape has been changed as mesh creation conditions. In this case, it is also possible to erase not only mesh information on the parts whose shape has been changed but also information on grid points in the entire partial area and newly set a mesh creation condition for the entire boundary.

Area merging step 6 is a step of eliminating overlapping from the state in which the areas are placed overlapped in partial area moving step 5. That is, this is a step of removing the areas of the same shape as those of the respective partial areas from the total area 17 and embedding the respective partial areas in the empty spaces. This is a so-called Boolean calculation executed in 3D-CAD or the like. This area merging step 6 is performed by the area merging unit 29 in the analysis mesh creation apparatus.

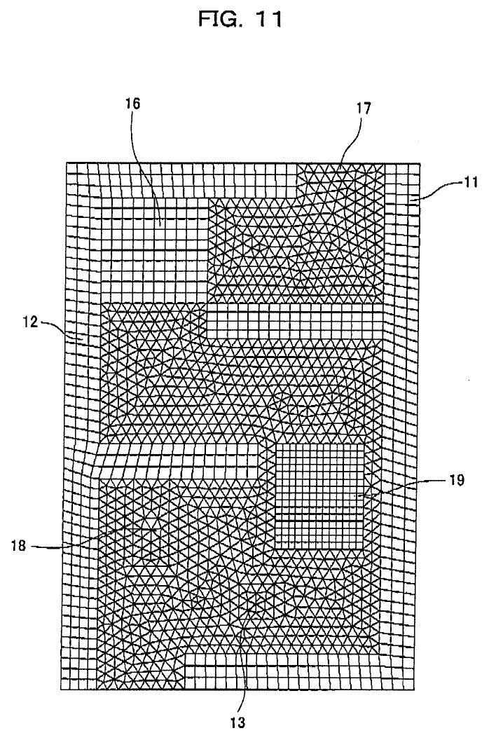

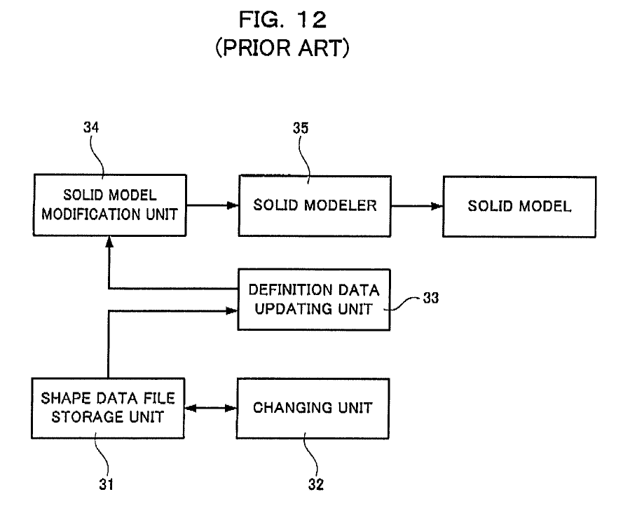

Merging such areas often causes inconsistencies of mesh division on their joint surfaces as shown in FIG. 10 and since mesh information of some of the partial areas is lost accompanying the aforementioned shape changes, mesh division should be performed in next mesh division step 7 again as shown in FIG. 11. Here, by using partial mesh division and overall mesh division properly depending on the necessity, it is possible to efficiently create new analysis meshes. This mesh division step 7 is performed by the mesh division unit 30 in the analysis mesh creation apparatus.

By creating a new analysis mesh whose shape is modified from the analysis mesh 10 through the aforementioned work procedure, it possible to efficiently create a new analysis mesh based on the analysis mesh even when there is no source 3D-CAD data. Particularly, instead of dividing the entire source analysis mesh 10 into partial areas, by defining the total area 17, making necessary modifications to other partial areas and performing the processing in area merging step 6, it is possible to eliminate the necessity for the work of maintaining consistencies in the modified parts between the partial areas and drastically save time and effort for modifying the shape.

That is, the present invention can provide a method of easily creating a new analysis mesh based on an existing analysis mesh. Even in a situation in which past analysis meshes exist but no source 3D-CAD model is found, which is a case that often occurs in an actual development field, it is possible to make a desired change of shape and create a new analysis mesh. Therefore, it is possible to save time and effort to create a new 3D-CAD model and efficiently perform shape examinations through a CAB analysis.

The analysis mesh creation method and analysis mesh creation apparatus according to the present invention is applicable to a wide range of fields where a CAE analysis such as structural analysis and fluid analysis is performed and is a method effective especially in the field of fluid analysis which targets even a spatial area for analysis.

What is claimed is:

1. An analysis mesh creation method comprising:
a division step of dividing an analysis mesh into a plurality of closed areas having information on a shape and a position;
a partial area registration step of storing the closed areas combined with attribute information on physical properties and meshes as a partial area;
a total area registration step of storing a total area which is an area combining all the partial areas and having attribute information on the specific partial area;
a partial area changing step of changing the partial area desired to be changed;
a partial area moving step of optionally changing a position of the partial area;
an area merging step of constructing a new analysis model by combining the total area and the at least one partial area using the position information; and
mesh division step of performing mesh division on the constructed analysis model and thereby creating a new analysis mesh.

2. The analysis mesh creation method according to claim 1, wherein the attribute information comprises physical property value information on a physical characteristic and mesh information including relative position information and connection information of grid points.

3. The analysis mesh creation method according to claim 1, wherein the division step uses any one or a combination of both of a method whereby physical property value information of an analysis mesh is used for a division into a plurality of closed areas by type of substance and a method whereby shape information of the analysis mesh is used for a division into a plurality of closed areas.

4. The analysis mesh creation method according to claim 1, wherein the partial area changing step can optionally change the shape of the partial area and also maintain physical property value information.

5. The analysis mesh creation method according to claim 1, wherein the partial area changing step can maintain the shape of the partial area and also change physical property value information.

6. The analysis mesh creation method according to claim 1, wherein the partial area changing step can create a copy of any partial area.

7. The analysis mesh creation method according to claim 1, wherein the partial area moving step calculates an absolute position of a grid point from relative position information of the grid point in the mesh information included in the attribute information as the position of the partial area is changed.

8. The analysis mesh creation method according to claim 1, wherein the mesh division step newly performs mesh division only on the partial area whose shape has been changed in the partial area changing step.

9. The analysis mesh creation method according to claim 1, wherein the mesh division step newly performs mesh division only on a portion where inconsistencies have occurred between the mesh information of the partial area and mesh information of the total area in the area merging step.

10. An analysis mesh creation apparatus comprising an input apparatus, a calculation apparatus, a storage apparatus and a display apparatus,
wherein the calculation apparatus comprises:
a division unit that divides an analysis mesh into a plurality of closed areas;
a partial area registration unit that stores the closed areas combined with attribute information on physical properties and meshes as a partial area;
a total area registration unit that stores a total area which is an area combining all the partial areas and having attribute information on the specific partial area;
a partial area changing unit that changes the partial area desired to be changed;
a partial area moving unit that optionally changes a position of the partial area;
an area merging unit that constructs a new analysis model by combining the total area and the at least one partial area using the position information; and
a mesh division unit that performs mesh division on the constructed analysis model.
